(19) United States
(12) Patent Application Publication
(10) Pub. No.: US 2004/0134619 A1
(43) Pub. Date: Jul. 15, 2004

(54) Paste application apparatus

(75) Inventor: Junichi Kojima, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHIBAURA MECHATRONICS CORPORATION, Yokohama-shi (JP)

(21) Appl. No.: 10/686,564

(22) Filed: Oct. 17, 2003

(30) Foreign Application Priority Data
Apr. 23, 2002 (JP) P2002-120958

(51) Int. Cl. B32B 31/00

(52) U.S. Cl. 156/356; 156/578

(57) ABSTRACT

A paste application apparatus includes a robot mechanism for holding a syringe storing paste material and a controller for controlling the operation of the robot mechanism. The robot mechanism further takes charge of delivering the syringe to a holding mechanism and also connecting and disconnecting a pipe to be connected with the syringe. By this robot mechanism, the exchange of an empty syringe for a new syringe can be carried out without an operator automatically. It is possible to reduce an operator's burden and enhance the operating efficiency in applying the paste material.

### CROS-REFERENCE TO RELATED APPLICATION

This application is based upon the prior Japanese Patent Application No. 2002-120958, filed on Apr. 23, 2002; the entire contents of which are incorporated herein by reference.

### BACKGROUND OF THE INVENTION

1. Field of the Invention

The present invention relates to a paste application apparatus for applying paste material on the surface of a substrate.

2. Description of the Related Art

Japanese Patent Application Laid-open No. 2000-59017 discloses a paste application apparatus that is capable of applying plural kinds of viscous fluid on a printed circuit board. This paste application apparatus is equipped with a movable dispenser head that allows viscous fluid, such as adhesive agent, to be applied on the printed circuit board in a designated position thereof. The dispenser head includes a movable head body and a dispenser unit detachably mounted on the head body. The dispenser unit is composed of a syringe, a nozzle and so on. In the paste application apparatus, there is provided an exchanger stage having a plurality of dispenser units. In operation, the dispenser head approaches the exchanger stage and performs the exchanging of the dispenser units. In this way, the single paste application apparatus is capable of applying plural kinds of viscous fluid on the printed circuit board.

### SUMMARY OF THE INVENTION

In the manufacturing process of a liquid crystal display panel or the like, it is performed to bond two pieces of glass substrates each interposing a liquid crystal layer therein, together. In order to accomplish this bonding operation for the glass substrates, adhesive agent as paste material is applied on one surface of one glass substrate opposing the other glass substrate.

As the adhesive agent, an ultraviolet (UV) cured sealant has been used frequently. As for the handling, this sort of paste material is once accommodated in a container of a syringe and thereafter into frozen storage until request of use. Subsequently, the paste material is defrosted in an atmosphere of from 20° C. to 25° C. in a constant temperature bath, and then retained in the constant temperature bath at the same temperature. Thereafter, the paste material is utilized for the applying operation in a clean room where temperature is adjusted to the same temperature.

In this process, if an operator comes in touch with the container to make the temperature of the container rise, it causes the quality of paste material to be deteriorated with ease thereby causing easy curing of the paste material. Noted that since the paste material comes out of commission once it has been hardened, the paste material will be scrapped. Or if the frequency of an operator's touch with the container is increased, the possibility for foreign objects, such as dust, to enter the container is enhanced. As a result, the inferior bonding of the substrates occurs with high possibility.

We now study the application of the above-mentioned paste application apparatus to the manufacturing process of liquid crystal display panels. In this case, the operator has to install the dispenser unit having a syringe, a nozzle, pipes and a frame on the exchanger stage. Normally, when the syringe becomes empty or a little paste material remains in the syringe, not the syringe is supplemented with paste material and but the syringe is exchanged whole. Consequently, as the preliminary step to installing the dispenser unit on the exchange stage, the operator has to mount the syringe on the frame, and to mount a new syringe on the frame after separating a used syringe from the frame. The operator has to spend a lot of time on these works. Accordingly, the opportunity and time for the operator to touch the syringe in which paste material is charged is increased to enhance the possibility of deteriorating the quality of paste material and the possibility of foreign objects to be mixed in, thereby causing the above-mentioned problem.

Further, an operator has to separate the syringe only from the nozzle, the pipes and the frame of the used dispenser unit and scrap the syringe only, so that the junking operation is complicated. Further, since the operator has to assemble the new dispenser unit and install a new syringe to the frame, the working efficiency is also deteriorated.

As the paste application apparatus that can be employed for the manufacturing process of the liquid crystal panels, meanwhile, there is supposed an apparatus as shown in FIG. 1.

FIG. 1 is a structural view of the paste application apparatus that receives a glass substrate transferred by a transfer robot and applies paste material on the surface of the substrate. FIG. 2 is an enlarged perspective view of the paste application apparatus of FIG. 1.

As shown in FIG. 1, the substrates 2 transferred onto a supply table 1 in order are each held by vacuum by a transfer robot 3. Then, the transfer robot 3 transports the substrate 2 in the direction of arrow X forming a transfer line. The substrates 2 are supplied to respective stages 4A of paste application apparatuses 41 to 44 opposing each other every two apparatuses, in order.

The reason why four paste application apparatuses are arranged so as to face the transfer line (X-direction) is to produce conformity between throughput time in the paste applying process and that in the other process in view of enhancing the whole productivity in assembling the substrates.

As these (four) paste application apparatuses 41 to 44 are provided with the same structures, FIG. 1 illustrates the structure of the single paste application apparatus 41 only and therefore, the essential parts of the other apparatuses are eliminated.

FIG. 2 is a perspective view of the paste application apparatus 41 in enlargement. The paste application apparatus 41 is equipped, on the stage 4A, with a vacuum suction hole and a plurality of pins (both not shown) movable vertically (i.e. a direction of arrow Z of FIG. 2). In operation, these pins are elevated to receive the substrate 2 from the transfer robot 3 and subsequently, the pins are lowered together with the substrate 2. Then, the lowered substrate 2 is held by the vacuum suction hole in vacuum suction.

The stage 4A is supported by an X-Y-θ moving mechanism 4B, especially on its “θ” (rotary) mechanism. This “θ” mechanism is supported by a Y-axis moving mechanism 4B1 and further, the Y-axis moving mechanism 4B1 is supported by an X-axis moving mechanism 4B2. The whole X-Y-θ moving mechanism 4B is mounted on a table (base) 4C.

When delivering the substrate 2, the stage 4A moves forward close to the transfer robot 3. While, when applying the paste material to the substrate 2, the stage 4A moves backward so as to withdraw from the transfer robot 3.

Prior to the beginning of a paste applying operation, the substrate 2 held on the stage 4A is adjusted in its reference position with respect to a head mechanism 4D equipped with two syringes 4D1, 4D2. The (two) syringes 4D1, 4D2 are containers that store paste material therein. As for a “multiple” substrate 2 (i.e. one substrate having a plurality of identical substrates formed therein), an interval between two syringes 4D1, 4D2 is established so as to correspond to a “X-directional” pitch of the adjoining substrates forming the multiple substrate 2.

Regarding the substrate 2 mounted on the stage 4A, it is noted that the substrate 2 is mostly positioned while including somewhat displacements in the directions X, Y and θ due to the delivery operation of the transfer robot 3.

In the head mechanism 4D, as shown in FIG. 1, the syringes 4D1, 4D2 are equipped with CCD cameras 4D3, 4D4, respectively. Pictures of alignment marks taken by the CCD cameras 4D3, 4D4 are fed to a controller 4E. At the controller 4E, due to its pattern recognizing control, it is carried out to adjust the position of the substrate 2.

After adjusting the position of the substrate 2, due to its programmed control, it is carried out to form a paste pattern on the surface of the substrate 2 while controlling the discharge volume of the paste material from respective nozzle of the syringes 4D1, 4D2. As shown in FIGS. 1 and 2, the controller 4E is connected with a monitor display 4F and a keyboard 4G, allowing an operator (worker) to control the paste applying operation for the substrate 2 by manipulating the keyboard 4G.

The substrate 2 having the paste material applied thereon moves forward and is delivered to the transfer robot 3. On receipt of the substrate 2, the transfer robot 3 transports it to an unloading table 5 of FIG. 1 for the next process.

As described above, in accordance with the programmed control for the X-Y-θ moving mechanism 4B and the syringes 4D1, 4D2 by the controller 4E, the paste application apparatus controls the paste discharging volume through the nozzles, so that a designated pattern is formed on the substrate 2.

As a result of paste applying, the resultant empty containers, that is, the syringes 4D1, 4D2 are detached from the head mechanism 4D and attached new other syringes having the paste material filled up to the head mechanism 4D by an operator's handwork.

As the substrate has been large-sized recently, the paste consumption for a single substrate is increased gradually. So that the exchanging times for the containers are increased thereby causing a burden on an operator to be increased.

Additionally, since the operator must spend a lot of time on the exchanging operation, when increasing the opportunity and time for an operator to touch the syringes, there is also increased the possibility of problems that the quality of the paste material is deteriorated and mixed with foreign substances.

Therefore, the object of the present invention is to provide a paste application apparatus that can accomplish automated exchanging operation for the containers to lessen an operator's burden while preventing deterioration of the quality of paste material and interfusion of foreign substances.

According to the present invention, the above object is accomplished by a paste application apparatus comprising: a container storing paste material and having a nozzle for applying the paste material discharged therefrom to a substrate; a stage adapted to mount the substrate thereon; a holding mechanism adapted to hold the container detachably; a moving mechanism enabling at least either one of the stage and the holding mechanism to move so that the nozzle of the container held by the holding mechanism and the substrate can move relatively to each other along a surface of the substrate; a discharge volume control unit connected to the container held by the holding mechanism through a pipe, for controlling a discharge volume of the paste material discharged from the nozzle; a delivery mechanism adapted so as to transfer the container to and from the holding mechanism; and a controller configured to control the transferring operation of the delivery mechanism.

According to the present invention, the paste application apparatus includes the delivery mechanism, and the controller. The delivery of the container between the delivery mechanism and the holding mechanism is controlled by the controller. Therefore, the exchanging operation can be automated to reduce an operator's burden remarkably. Further, since it is possible to decrease the opportunity that the operator touches the container, the paste material can be prevented from deteriorating in quality and being mixed with foreign substances.

These and other objects and features of the present invention will become more fully apparent from the following description and appended claims taken in conjunction with the accompany drawing.

### BRIEF DESCRIPTION OF THE DRAWINGS

FIG. 1 is a structural view of a paste application apparatus for liquid crystal panels;

FIG. 2 is an enlarged structural view of the paste application apparatus of FIG. 1;

FIG. 3 is a structural view of a paste application apparatus in accordance with an embodiment of the present invention;

FIG. 4 is an enlarged perspective view of the paste application apparatus of FIG. 3;

FIG. 5 is an enlarged perspective view of an essential part of the apparatus of FIG. 4;

FIG. 6 is an exploded perspective view explaining the exchanging order for the containers in the apparatus of FIG. 5;

FIG. 7A is a right side view of an essential part of the apparatus provided with a piping locking part of FIG. 4;

FIG. 7B is a sectional view taken along a line 7B-7B of FIG. 7A;

FIG. 8 is a front view of an essential part of FIG. 5;

FIG. 9A is a sectional view taken along a line 9A-9A of FIG. 8 and FIG. 9B is a sectional view taken along a line 9B-9B of FIG. 8;

FIG. 10A is a structural view of a supply device of the paste application apparatus of FIG. 3;

FIG. 10B is a perspective view of a holder for holding the syringe;

FIG. 11 is a right side view of an essential part of another robot mechanism of the embodiment of FIG. 4;

FIG. 12 is a right side view of an essential part of a further robot mechanism of the embodiment of FIG. 4; and

FIG. 13 is a plan view of an essential part of another transfer arm of a robot mechanism of the embodiment of FIG. 4.

### DESCRIPTION OF THE PREFERRED EMBODIMENT

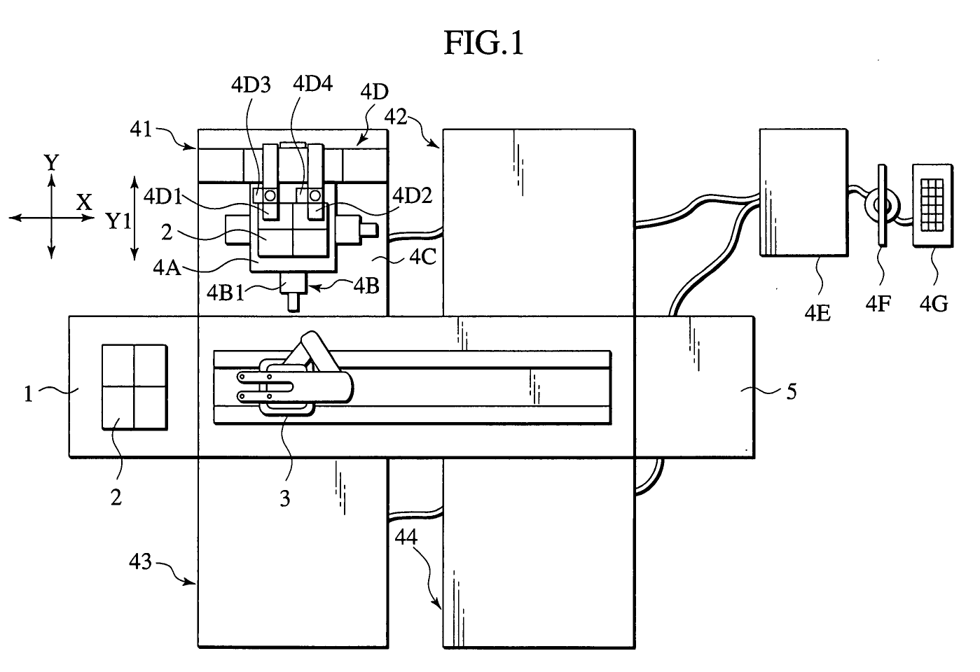

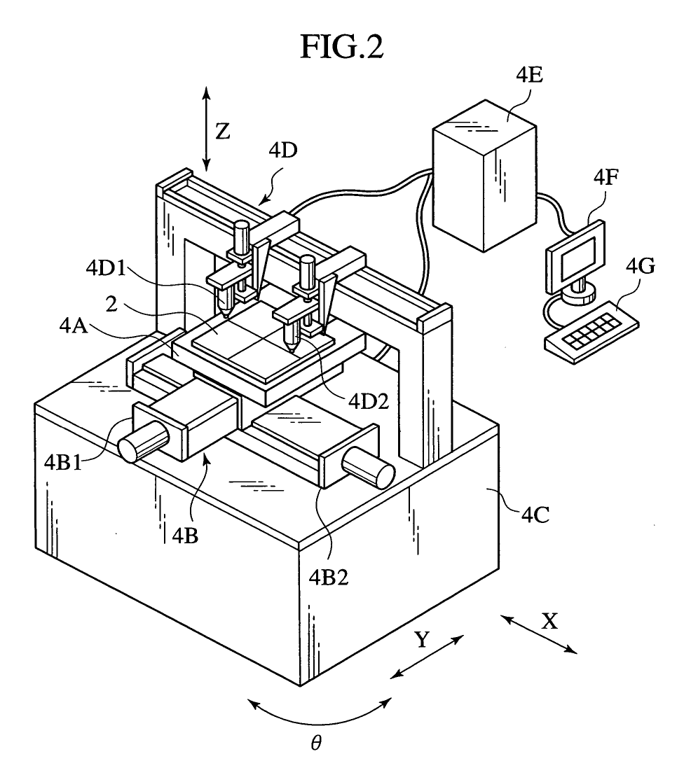

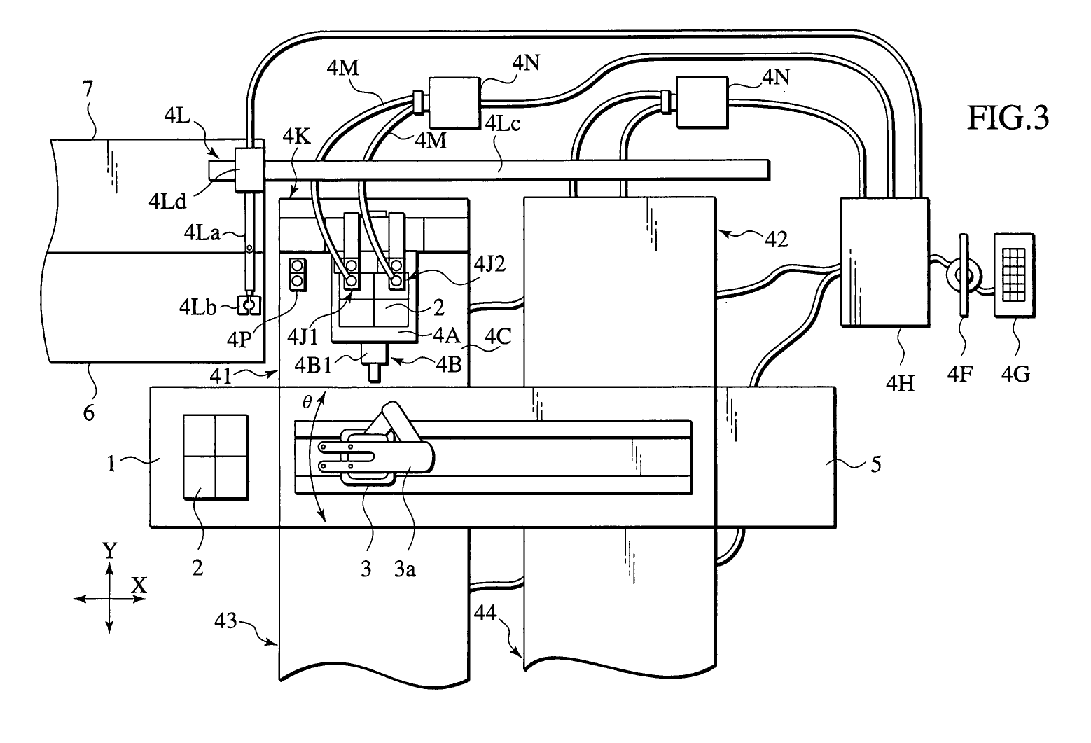

Referring to FIGS. 3 to 13, one embodiment of the paste application apparatus of the present invention will be described below. Note: elements identical to those of the paste application apparatus of FIGS. 1 and 2 are indicated with the same reference numerals respectively and their overlapping descriptions are eliminated.

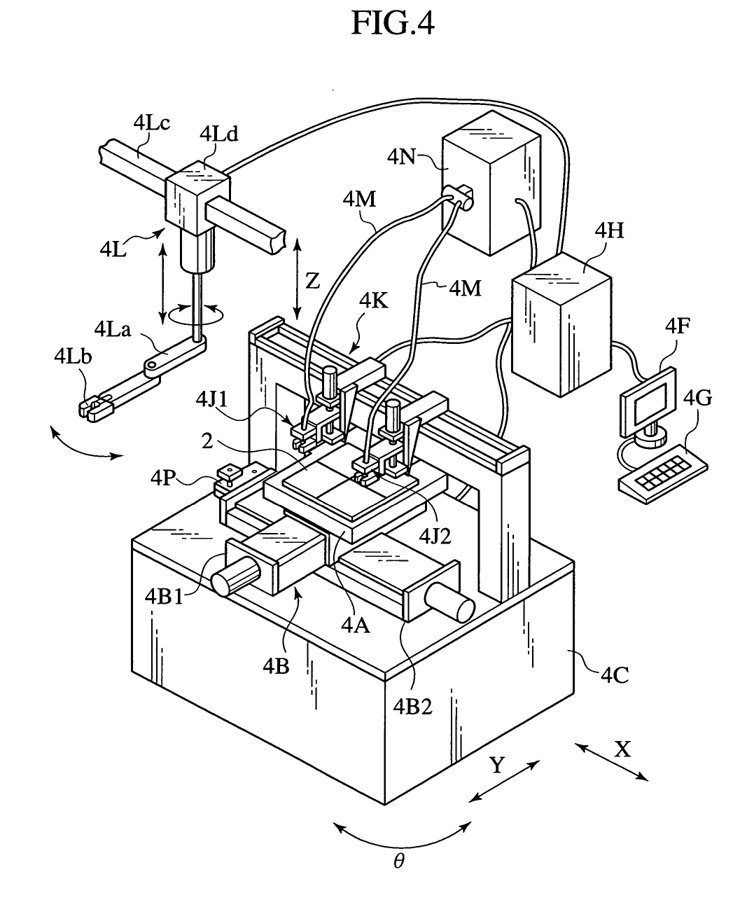

FIG. 3 is a structural view of the relevant part of a pasting system including a plurality of paste application apparatuses of the first embodiment of the present invention. FIG. 4 is an enlarged perspective view of the paste application apparatus of FIG. 3.

As shown in FIG. 3, the substrate 2 transferred onto the supply table 1 in sequence is held by vacuum by an arm 3a of the transfer robot 3 and subsequently supplied to four paste application apparatuses 41 to 44 by the arm's rotary movement (in the direction θ) and transporting movement (in the direction X) in order, similar to the operation of the apparatus of FIG. 1.

Each of the paste application apparatuses 41 to 44 is equipped with the stage 4A for receiving and mounting the substrate 2 thereon and the X-Y-θ moving mechanism 4B incorporating the stage 4A.

As similar to the arrangement of FIG. 1, the stage 4A is supported by the Y-axis moving mechanism 4B1 through the rotatable θ mechanism of the X-Y-θ moving mechanism 4B, while the Y-axis moving mechanism 4B1 is supported by the X-axis moving mechanism 4B2.

In this way, due to the arrangement of the θ mechanism on the Y-axis moving mechanism 4B1 of the X-Y-θ moving mechanism 4B, it is capable of forward movement up to the delivery position of the substrate 2 toward the transfer robot 3 and backward movement up to the applying position apart from the transfer robot 3 with the control of a controller 4H on the Y-axis moving mechanism 4B1.

Similarly to the arrangement of FIG. 1, the stage 4A is provided, on its surface, with a plurality of pins and a vacuum suction hole. In operation, the substrate 2 is received by the plural pins and mounted thereon. Thereafter, the substrate 2 is lowered together with the pins and finally held by the vacuum suction hole. Conversely, when delivering the substrate 2 to the transfer robot 3, the operation is carried out in the opposite order to above.

As shown in FIG. 4, the paste application apparatus of this embodiment is equipped, on the table (base) 4C, with the X-Y-θ moving mechanism 4B and a holding mechanism 4K having two containers storing paste material, that is, two syringes 4J1 and 4J2 detachably mounted thereon.

Since the substrate 2 on the stage 4A moves in relation with the nozzles of the syringes 4J1, 4J2 in accordance with the programmed control of the controller 4H, a paste pattern of the paste material discharged from the nozzles is formed on the surface of the substrate 2.

As shown in FIGS. 3 and 4, the paste application apparatus of this embodiment is constructed so as to discharge the paste material from the nozzles of the (two) syringes 4J1, 4J2 and apply it to the surface of the substrate 2 simultaneously. Here noted that these syringes 4J1, 4J2 held by the holding mechanism 4K have the same structures to each other. Therefore, we now describe the structure of one syringe 4J1 representatively, and the description of the structure of the other syringe 4J2 will be eliminated.

In the paste application apparatus of this embodiment, a robot mechanism 4L forming the delivery mechanism delivers the syringe 4J1 storing the paste material to the holding mechanism 4K and also receives the syringe 4J1, which has been emptied as a result of consuming the paste material, from the mechanism 4K, namely the robot mechanism 4L performs a loading and receiving operation of the syringe 4J1.

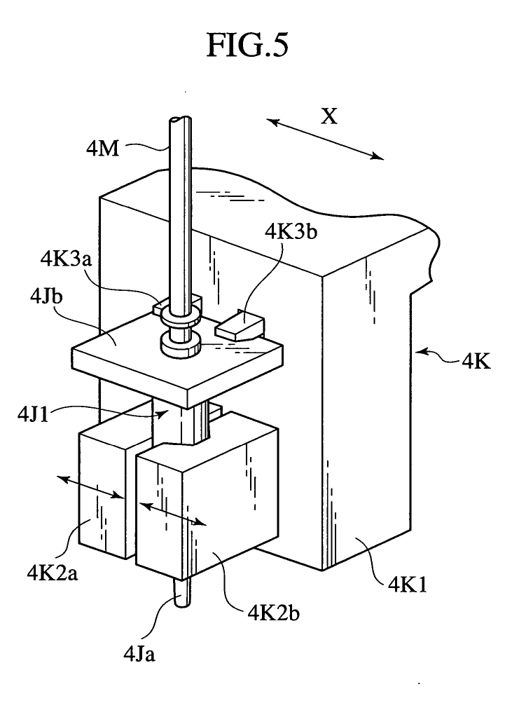

FIG. 5 is an enlarged perspective view showing a condition where the syringe 4J1 is fitted to a holder body 4K1 of the holding mechanism 4K. The syringe 4J1 having a coaxial nozzle 4Ja and storing the paste material therein, in the form of a cylindrical container, is detachably fitted to the holder body 4K1 of the holding mechanism 4K. The holder body 4K1 carrying the syringe 4J1 is movable in the direction X.

In the holding mechanism 4K, the holder body 4K1 is equipped with a pair of arms 4K2a, 4K2b that open and close in the direction X to grasp the syringe 4J1. The syringe 4J1 pinched between the arms 4K2a and 4K2b is connected with a discharge volume control unit 4N (see FIGS. 3 and 4) through a pipe 4M. The discharge volume control unit 4N is connected with a not-shown pump. Thus, the pair of arms 4K2a, 4K2b of the holder body 4K1 form the grasping part. With the closing action of the arms 4K2a, 4K2b, they pinch the cylindrical syringe 4J1 in the diametral direction to grasp it.

The discharge volume control unit 4N is connected with the controller 4H, thereby effecting pressure control to the syringe 4J1 in a manner that an appropriate amount of paste material can be discharged from the nozzle 4Ja of the syringe 4J1 in exact timing with the application of paste material to the substrate 2.

FIG. 5 shows a state that the syringe 4J1 connected with the pipe 4M is grasped by the holder body 4K1. In addition to FIG. 5, referring to FIGS. 3, 4 and 6 to 9, we now describe the processing order where the syringe 4J1 is delivered to the holder body 4K1 by the robot mechanism 4L.

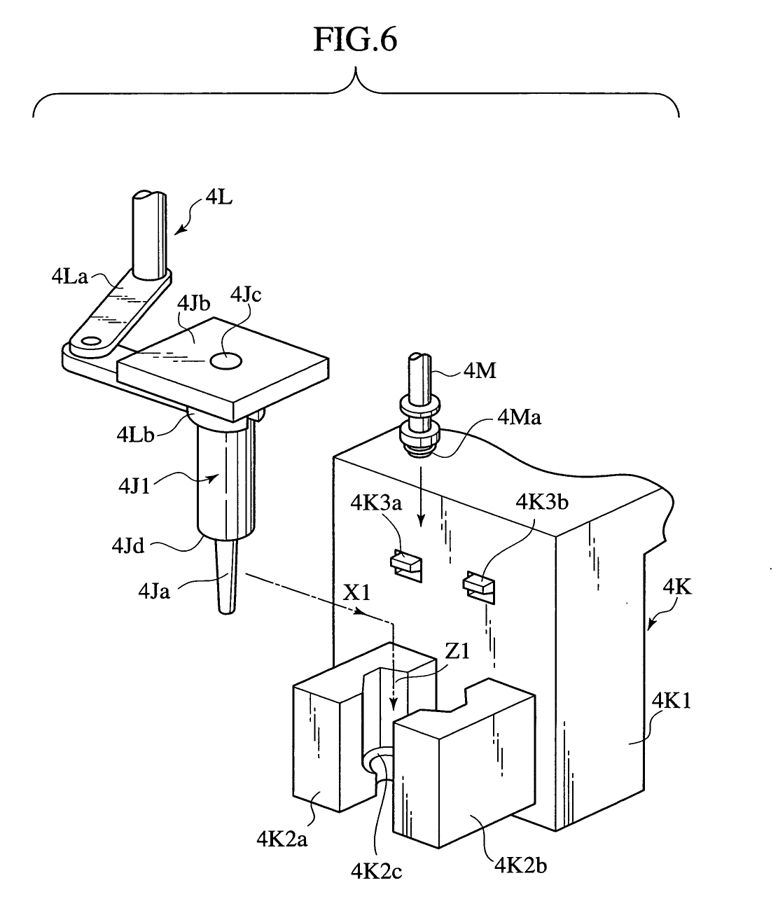

FIG. 6 is an enlarged and exploded view explaining the order where the syringe 4J1 carried by the robot mechanism 4L is fitted to the holder body 4K1. As shown in FIGS. 3 and 4, the robot mechanism 4L has a transfer arm 4La whose tip is connected with a holding part 4Lb. The transfer arm 4La is rotatable about the vertical axis by a drive mechanism (not shown). The syringe 4J1 held by the holding part 4Lb is transferred along the direction of arrow X1 of FIG. 6. After that, the syringe 4J1 is lowered in the direction of arrow Z1 and inserted between the pair of arms 4K2a and 4K2b in the opened state. The so-inserted syringe 4J1 is grasped by the holder body 4K1 with the closing action of the arms 4K2a, 4K2b. At this time, the stoppers 4K3a, 4K3b retreat into the holder body 4K1 to prevent the syringe 4J1 from interfering with the stoppers 4K3a, 4K3b.

As shown in FIG. 5 or FIG. 6, the syringe 4J1 is provided, at its upper end, with a brim part 4Jb forming the engagement part. On the lower part of the syringe 4J1, a step part is provided with an abutment surface 4Jd. The syringe 4J1 is grasped by the holder body 4K1, and then the upper face of the engagement part is slightly pressed down by stoppers 4K3a, 4K3b projecting laterally from the holder body 4K1. Further, since the step part having the abutment surface 4Jd comes in abutment with step parts 4K2c of the arms 4K2a, 4K2b in pairs, the syringe 4J1 can be supported by the holder body 4K1 in the axial direction, i.e., the vertical direction, stably.

The brim part 4Jb of the syringe 4J1 is provided with an opening 4Jc with which the pipe 4M is detachably connected.

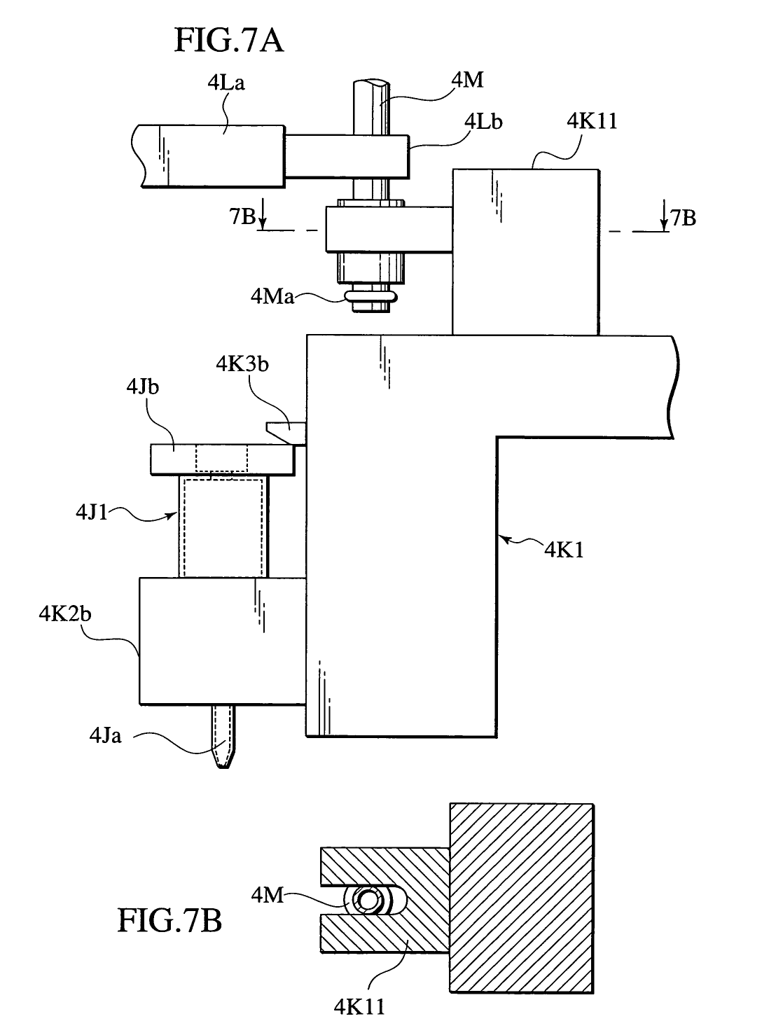

As shown in FIG. 7A and FIG. 7B, the holder body 4K1 is provided with a piping engagement part 4K11 having a U-shaped recess, while the brim part of the pipe 4M is engaged with the piping engagement part 4K11 temporarily. Under such a situation, the holding part 4Lb of the robot mechanism 4L catches the pipe 4M to detach it from the piping engagement part 4K11 and successively fits the connecting part of the pipe 4M to the opening 4Jc of the syringe 4J1.

When the paste material in the syringe 4J1 is consumed up, it is replaced with a new syringe in the opposite order to the above-mentioned order.

According to this embodiment, a stocker 4P is arranged on the table 4C in order to effect the exchanging operation of the robot mechanism 4L for the syringes 4J1, 4J2, as shown in FIGS. 3 and 4. The stoker 4P has a plurality of holder parts for detain the syringes 4J1. The stocker 4P serves to detain an emptied-and-exchanged syringe and a new syringe for exchange temporarily.

Noted the above stocker 4P may be arranged in the vicinity of the stage 4A, as shown in FIGS. 3 and 4. Alternatively, the stocker 4P may be arranged on the stage 4A directly.

As mentioned above, the robot mechanism 4L of this embodiment includes a delivery mechanism for transferring the syringe 4J1 to and from the holder body 4K1 and an attaching and detaching mechanism for connecting and disconnecting the pipe 4M to and from the syringe 4J1 thereby connecting and separating the syringe 4J1 to and from the discharge volume control unit 4N.

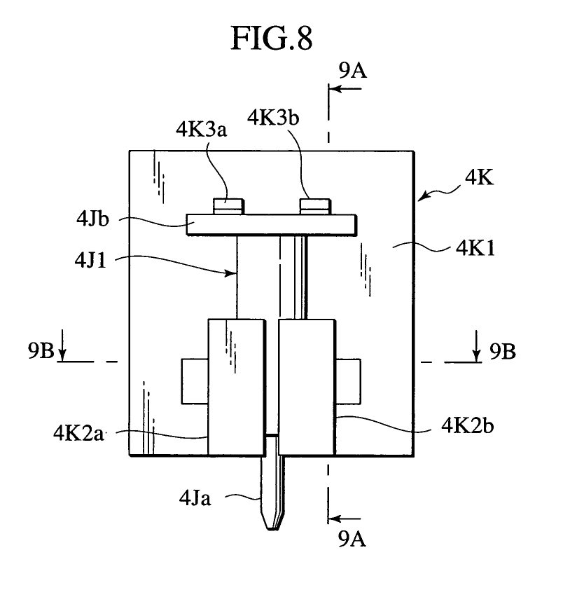

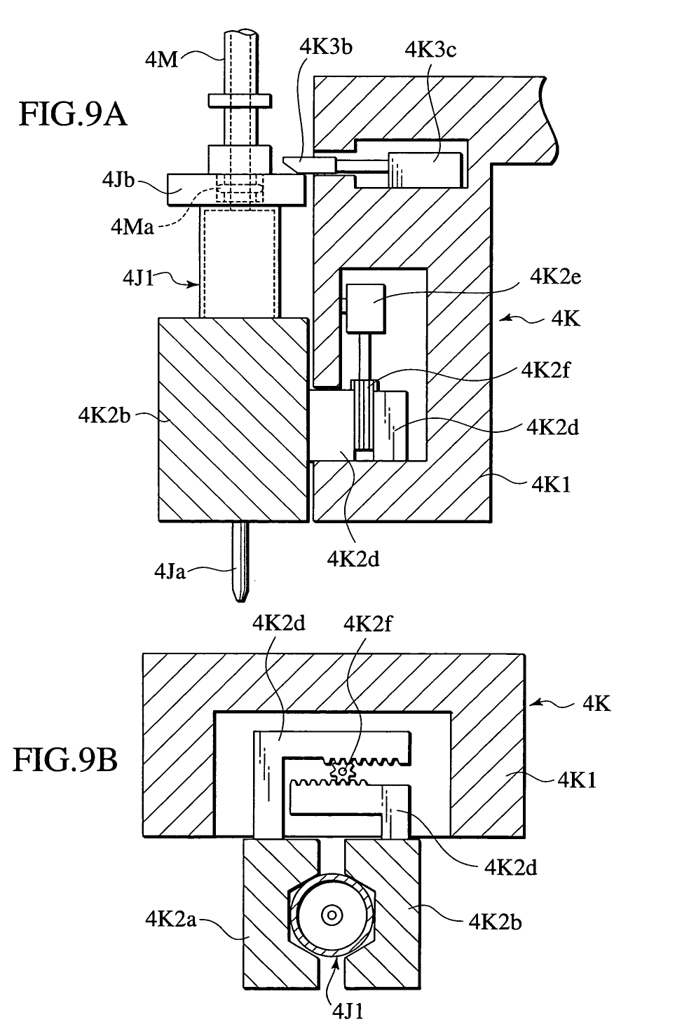

Referring to FIGS. 8 and 9 (9A, 9B), the detailed structure of the holder body 4K1 will be described. In these figures, FIG. 8 is a front view of an essential part shown in FIGS. 5 and 7 (7A, 7B). FIG. 9A is a sectional view taken along a line 9A-9A of FIG. 8, while FIG. 9B is a sectional view taken along a line 9B-9B of FIG. 8.

As shown in FIG. 9B, in the holder body 4K1, there are opposed L-shaped meshing parts 4K2d, 4K2d which continue into the arms 4K2a, 4K2b, respectively. Interposed between the opposing meshing parts 4K2d, 4K2d is a gear 4K2f that is rotated by a servo-motor 4K2e. The gear 4K2f engages with both of the meshing parts 4K2d, 4K2d. Since the rotation of the servo-motor 4K2e is controlled by the controller 4H, the arms 4K2a, 4K2b are opened or closed.

The stoppers 4K3a, 4K3b are constructed so as to be movable back and forth by the operation of an actuating cylinder (or two cylinders) 4K3c. Therefore, since the drive of the cylinder 4K3c is controlled by the controller 4H, it becomes possible to overbear the syringe 4J1 from the upside and release it.

When it becomes necessary to exchange the syringes 4J1, 4J2 for new ones as a result of consuming the paste material in the syringes 4J1, 4J2, the controller 4H controls the operations of the servo-motor 4K2e and the cylinder 4K3c in addition to the control of the robot mechanism 4L. In this way, the disinstallation of the pipe 4M and the disinstallation of the syringes 4J1, 4J2 from the holding mechanism 4K are carried out. As stated before, the robot mechanism 4L take charge of attaching and detaching the pipe 4M to and from the opening 4Jc of the syringe 4J1. In connection, an O-ring 4Ma is fitted to the connecting part at the leading end of the pipe 4M. The provision of the O-ring 4Ma allows the pipe 4M to be connected to the syringe 4J1 tightly.

Here noted that each of the syringes 4J1, 4J2 as the containers is gripped by the arms 4K2a, 4K2b in the diametral direction of the syringe. Additionally, also in a direction perpendicular to the above gripping direction, the syringes 4J1, 4J2 are each gripped by the step part 4K2c and the stoppers 4K3a, 4K3b strongly. Accordingly, even after the attaching/detaching operation of the pipe 4M for the robot mechanism 4L that exerts a considerable force to the syringe 4J1, 4J2, the level of the tip of the nozzle 4Ja is stabilized with high repeatability to maintain an interval between the substrate 2 and the tip of the nozzle 4J1 with high accuracy, whereby the paste material can be applied to the substrate 2 appropriately.

As shown in FIGS. 3 and 4, the robot mechanism 4L has a guide rail 4Lc laid along the transferring direction (X direction) of the substrate 2. Therefore, the robot body 4Ld is movable along the guide rail 4Lc. With this movement, the robot body 4Ld can transfer the containers (i.e. the syringes 4J1, 4J2) to and from the respective holding mechanisms 4K of the paste application apparatuses 41, 42 arranged in the direction X.

The controller 4H also judges whether the container held by the holding mechanism 4K is emptied or not (or judges whether the exchange for a new container is required since the quantity of paste material in the present container runs short). In detail, for example, the controller 4H counts the number of substrates 2 that have been applied with the paste material. When the number of so-counted substrates 2 amounts to a predetermined number, the controller 4H judges that an exchange time for a new container has come. Successively, the controller 4H controls to start the exchange operation automatically. Of course, an operator may judge the exchange time and further command the controller 4H to exchange the empty container for a new one.

Alternatively, there may be provided a sensor for detecting the weight of a container on use. In this modification, when the weight of the container on use becomes less than a predetermined weight, the controller 4H judges that the container has been just emptied and continuously carries out the exchange operation of the containers (old, new ones). Alternatively, the container may be exchanged when the accumulated time of paste discharge time reaches to a predetermined time.

As mentioned above, according to the paste application apparatus of the embodiment, since the robot mechanism forming the delivery mechanism of the containers (syringes 4J1, 4J2) and the attaching and detaching mechanism of the pipe 4M is capable of automatic exchange of an empty container for a new container in the course of applying the paste material on the substrate, there is no need for an operator to carry about the containers for exchange one by one, as shown in FIG. 1. Consequently, the burden on an operator can be reduced to improve the operative efficiency in applying the paste material to the substrate.

Additionally, since there is no possibility that an operator touches a container having the paste material stored therein at the exchange of the container (syringes 4J1, 4J2), it is possible to prevent the paste material from deteriorating in quality, because the paste material is warmed by the body temperature of the operator, and mixed with foreign substances derived from the operator.

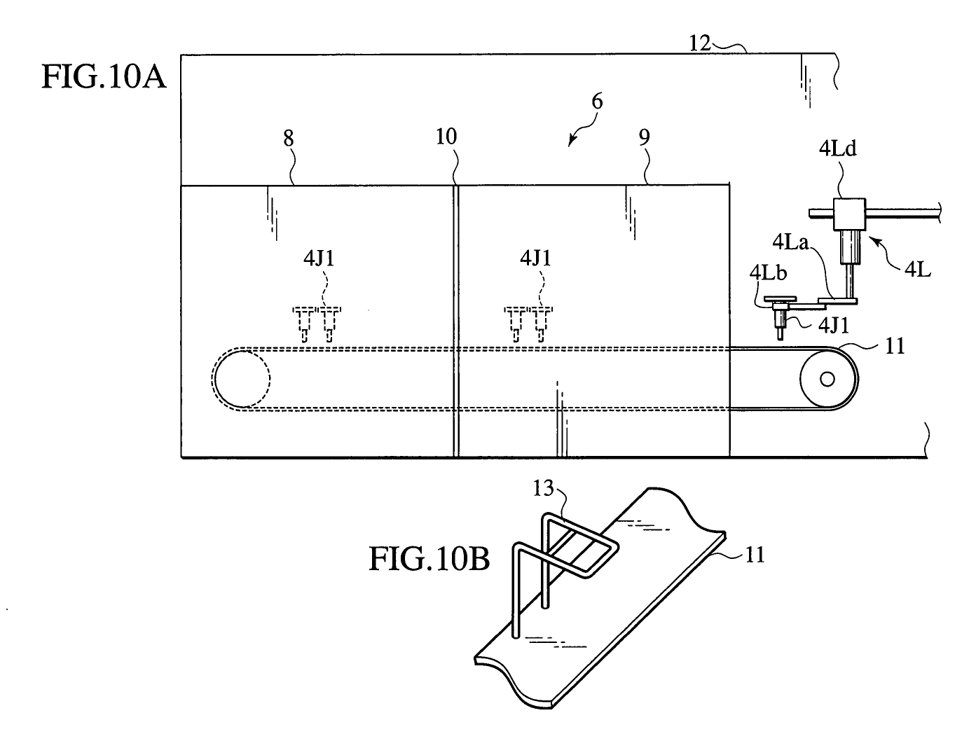

Next, a modification of the embodiment of the present invention is explained with reference to FIGS. 3, 10A and 10B.

In this modification, the robot mechanism 4L directly perform a delivery among the holding mechanism 4K, a supply device 6, and a disposal device 7 with passing the stocker 4P. While, in the embodiment described above, the operator conducts a supply of syringe 4J to the stocker 4P, in this modification, the opportunities that the operator comes into contact with the syringe 4J can be further reduced. In the embodiment described above, since the operator can put the syringe 4J1 on the stocker 4P at a short time, the paste material in the syringe 4J1 can be prevented from deteriorating in quality and being mixed with foreign substances.

In FIG. 3, reference number 6 denotes the supply device for supplying syringe 4J1 containing paste to the robot mechanism 4L. Reference number 7 denotes the disposal device for disposing of the empty syringe 4J1 that paste has been consumed, by the robot mechanism 4L.

FIG. 10A shows a supply device 6 that supplies a container filled with the paste material. The supply device 6 includes a freezer 8 for keeping the syringe 4J1 storing the paste material therein, in cold storage. An ultraviolet (UV) cured sealant is employed as the paste material. When ultraviolet rays are irradiated to the sealant after it has been applied to the substrate 2, the sealant hardens to maintain a gap between the substrates 2 in pairs to a vacuum.

A constant temperature bath 9 is arranged to be adjacent to the freezer 8. The interior of the constant temperature bath 9 is maintained within a range from 20° C to 25° C., preferably, about 23° C. In the bath 9, frozen paste material is thawed and maintained at about 23° C. Between the freezer 8 and the constant temperature bath 9, a shutter 10 is arranged to effect heat insulation therebetween.

A belt conveyer 11 shown in FIG. 10A takes charge of transporting the syringe 4J1 between the freezer 8 and the constant temperature bath 9. The belt conveyer 11 carries a holder 13 shown in FIG. 10B. The holder 13 stably holds the syringe 4J1 containing the paste material on the belt conveyer 11. Owing to the drive of the belt conveyer 11, the syringe 4J1 containing the paste material is transferred from the freezer 8 to the constant temperature bath 9 and further into a clean room 12 maintained at about 23° C. The freezer 8 and the constant temperature bath 9 and the paste applying apparatus 41-44 are installed inside the clean room 12. Then, the syringe 4J1 brought into the clean room 12 is held by the robot mechanism 4L and delivered to the holding mechanism 4K. It is controlled so as to use the thawed paste material within about 7 hours. If exceeding 7 hours, then the paste material gradually hardens to be out of commission because the paste material reacts ultraviolet rays contained in the illumination light in the clean room 12. The operations of the belt conveyer 11 and the shutter 10 are controlled by the controller 4H. In this modification, the same effects can be achieved as that of the embodiment described above, and there is a fewer opportunity at which an operator touches a container.

Noted, in the above-mentioned embodiment, the single robot mechanism 4K takes charge of the exchange operation for the containers (i.e. the syringes 4J1, 4J2) and the attaching/detaching operation for the pipe 4M, in order. In the modification, there may be provided one exclusive robot mechanism for exchanging the containers (forming the above delivery mechanism) and another exclusive robot mechanism for attaching and detaching the pipe 4M (forming the above attaching and detaching mechanism) to accomplish the similar effects and operations.

Alternatively, the single robot mechanism 4L may be constructed so as to carry out both exchanging of the containers and detaching/attaching of the pipe 4M simultaneously.

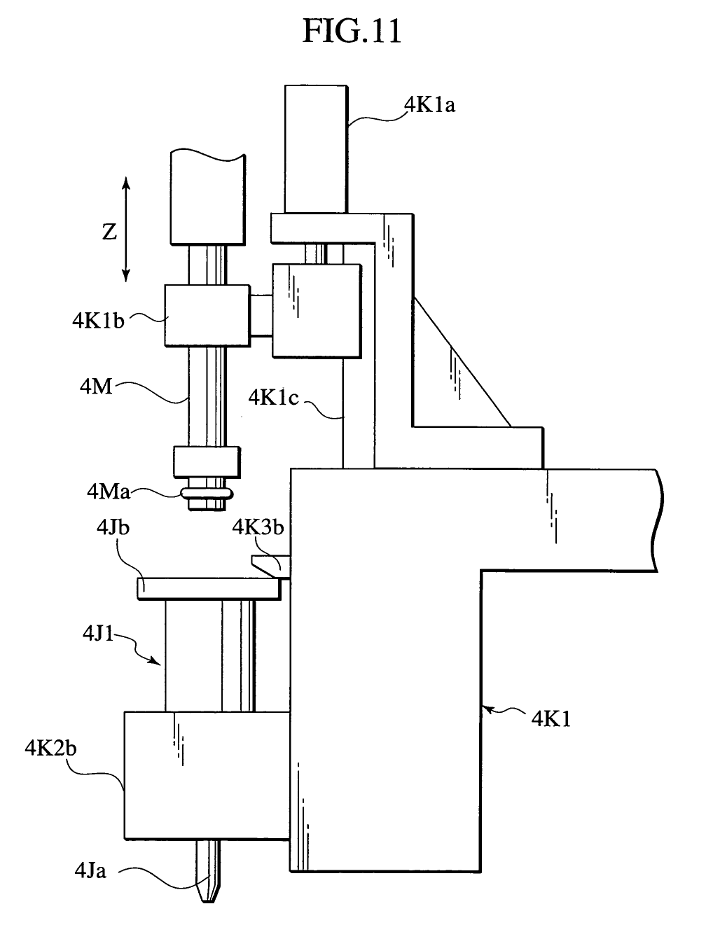

For example, as shown in FIG. 11, the holder body 4K1 is equipped with an air cylinder 4K1a that moves a connecting tool 4K1b carrying the pipe 4M up and down in the direction Z along a guide rail 4K1c. With the movement of the air cylinder 4K1a, it becomes possible to attach and detach the pipe 4M to and from a container (i.e. the syringe 4J1) held by the holder body 4K1. According to the structure of FIG. 11, there is no need to provide the holder body 4K1 with the previous piping engagement part 4K11 (see FIG. 7) for temporary engagement of the pipe 4M that has been extracted from the syringe 4J1.

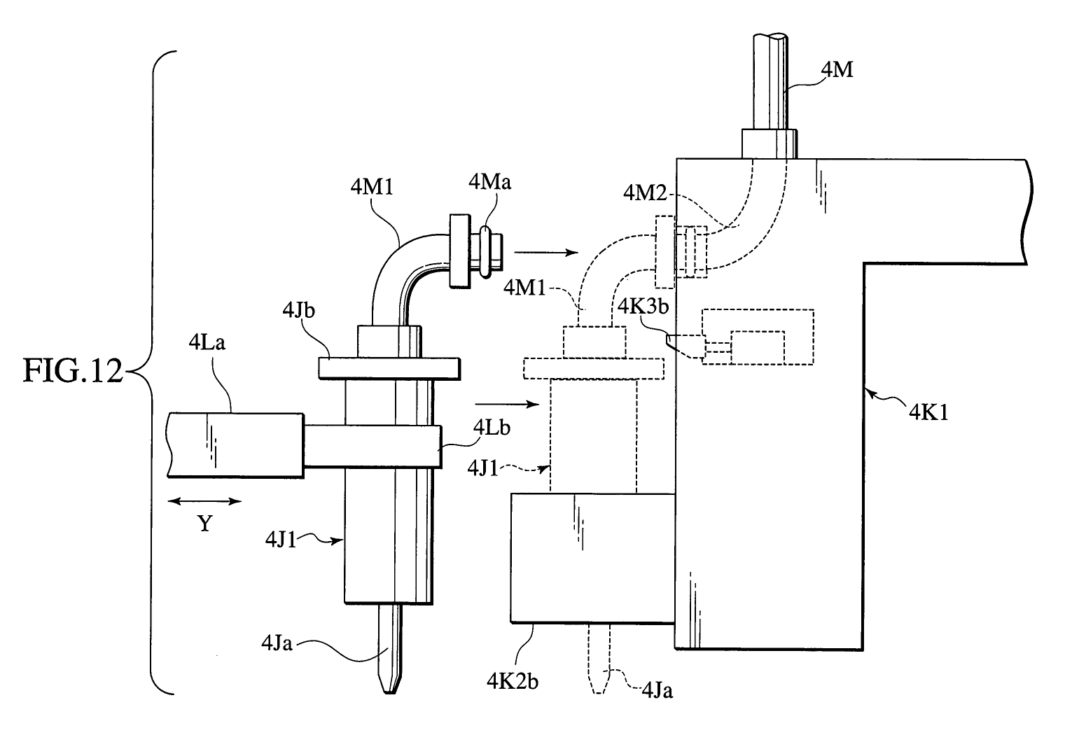

Further providing that a trunk pipe 4M1 is previously connected to the syringe 4J1, as shown in FIG. 12, the single robot mechanism 4L may be constructed so as to simultaneously perform one operation to attach/detach the syringe 4J1 to and from the holder body 4K1 and another operation to attach/detach the pipe 4M to and from a pipe receiver 4M2 in the holder body 4K1. Additionally, it is noted that the movement of the transfer arm 4La is different from that of FIG. 6. That is, as shown in FIG. 12, the movement of the arm 4La in the direction Y from the front of the holder body 4K1 allows the syringe 4J1 and the trunk pipe 4M1 to be attached/detached to and from the holder body 4K1 simultaneously. In connection, the opening/closing of the arms 4K2b (4K2a: not shown) and the slide movement of the stoppers 4K3b (4K3a: not shown) are synchronized with the above detachment/attachment of the syringe 4J1 and the trunk pipe 4M1.

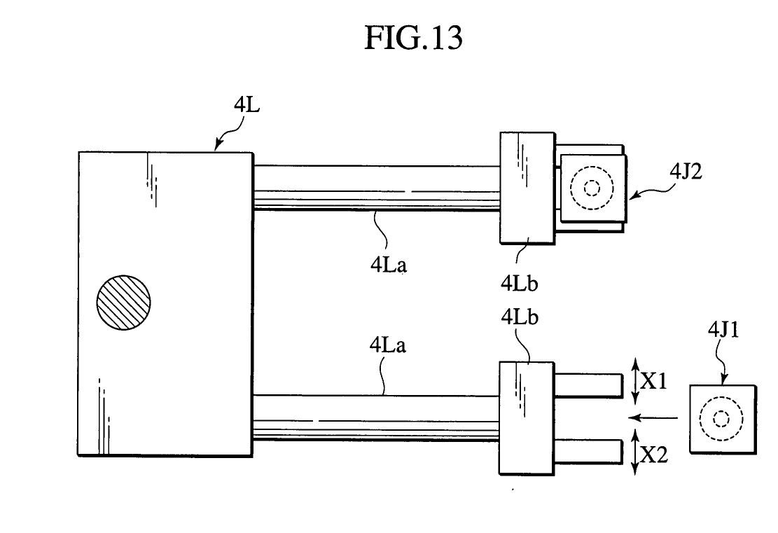

In the above-mentioned embodiment, we have described the robot mechanism 4L as grasping one container (the syringe 4J1), as a matter of explanation. In the modification, as shown in FIG. 13, the robot mechanism 4L may be equipped with a plurality of holding parts 4Lb (two in the figure) whose movements in the directions X1, X2 allow the containers (i.e. the syringes 4J1, 4J2) to be gripped. Then, owing to the provision of the plural holding parts 4Lb, it is possible to hold a used empty container with one holding part 4Lb, while transferring a new container charged with the paste material, which is held by the other holding part 4Lb, to the holder body 4K1, whereby the exchanging operation for the containers can be accomplished effectively.

As for the syringes 4J1 to be handled by the robot mechanism 4L, they may be provided with the same diameter or different diameters. In case of holding the syringes 4J1 of different diameters, the holding parts 4Lb may be constructed so as to hold the syringes 4J1 of different diameters. In detail, when handling two kinds of syringes 4J1 of large and small diameters, the holding part 4Lb may be equipped with a recess of a curvature corresponding to the large-diameter syringe 4J1 and another recess of a curvature corresponding to the small-diameter syringe 4J1. That is, in operation, the former recess takes charge of holding the large-diameter syringe 4J1, while the latter recess takes charge of holding the small-diameter syringe 4J1.

In the previously-mentioned embodiment of the invention, the paste material is applied to the substrate 2 while being moved by the X-Y-θ moving mechanism 4B. Alternatively, providing that the holding mechanism 4K is provided with an X-Y moving mechanism, the paste material may be applied to the substrate while moving the nozzle 4Ja.

Without applying only to the paste application apparatus for drawing a pattern linearly, the present invention is also applicable to a paste application apparatus for applying the paste material in points.

As mentioned above, according to the paste application apparatus of the invention, since it allows the exchange of the container to be performed mechanically and automatically, it is possible to reduce an operator's burden and enhance the operating efficiency in applying the paste material, thereby exhibiting a remarkable effect in practical use.

Though an adhesive agent serving as sealing material as paste material is used in the embodiments described above, the present invention can be adapted to a paste application for applying paste material except an adhesive agent.

Finally, it will be understood by those skilled in the art that the foregoing descriptions are one embodiment of the paste application apparatus and the modifications, and that various changes and further modifications may be made to the present invention without departing from the scope thereof.

What is claimed is:

1. A paste application apparatus comprising:
a container storing paste material and having a nozzle for applying the paste material discharged therefrom to a substrate;
a stage adapted to mount the substrate thereon;
a holding mechanism adapted to hold the container detachably;
a moving mechanism enabling at least either one of the stage and the holding mechanism to move so that the nozzle of the container held by the holding mechanism and the substrate can move relatively to each other along a surface of the substrate;
a discharge volume control unit connected to the container held by the holding mechanism through a pipe, for controlling a discharge volume of the paste material discharged from the nozzle;
a delivery mechanism adapted so as to transfer the container to and from the holding mechanism; and
a controller configured to control the transferring operation of the delivery mechanism.

2. A paste application apparatus as claimed in claim 1, further comprising an attaching and detaching mechanism adapted to connect and disconnect the container to and from the discharge volume control unit,
wherein the controller controls the connecting-and-disconnecting operation of the attaching and detaching mechanism.

3. A paste application apparatus as claimed in claim 1, wherein
the controller controls the delivery mechanism to load a container filled up with the paste material to the holding mechanism while receiving an empty container from the holding mechanism.

4. A paste application apparatus as claimed in claim 1, wherein
the container is a cylindrical container having an end where the nozzle is arranged coaxially, the cylindrical container having a container-step part having an abutment surface directing downwardly and an engagement part having an engagement surface directing upwardly;
the holding mechanism includes a grasping part having a holder-step part for contact with the abutment surface of the container-step part to grasp the cylindrical container in a diametral direction thereof and a stopper for engaging the engagement surface of the engagement part to make the abutment surface abut on the holder-step part; and
the pipe is provided with a connecting part detachable to the cylindrical container in an engaging direction of the stopper.

5. A paste application apparatus as claimed in claim 1, wherein the delivery mechanism is formed so as to carry two containers simultaneously.

6. A paste application apparatus as claimed in claim 5, wherein the delivery mechanism is formed so as to carry the container filled up with the paste material and the empty container separately.

7. A paste application apparatus as claimed in claim 1, further comprising a stocker for holding the container, the stocker being either arranged in the vicinity of the stage or formed in the stage itself.

8. A paste application apparatus as claimed in claim 1, wherein the controller is constructed, on a basis of consumption of the paste material in the container, so as to judge the necessity of the transferring operation of the containers by the delivery mechanism.

9. A paste application apparatus as claimed in claim 1, wherein
the controller is adapted to count the number of substrates that have been applied with the paste material, and
the controller is constructed so as to judge an exchange time for the container when the number of substrates counted amounts to a predetermined number, and successively start the transferring operation of the containers by the delivery mechanism.

10. A paste application apparatus as claimed in claim 1, further comprising a supply device for supplying a container storing the paste material therein and a disposal device where a used container is scrapped, wherein the delivery mechanism receives the container storing the paste material from the supply device and scraps the used container into the disposal device.

11. A paste application apparatus as claimed in claim 10, wherein the supply device includes:
a freezer for keeping the container storing the paste material therein, in cold storage; and
a constant temperature bath that receives the container storing the paste material therein from the freezer and preserves the container at a temperature ranging from 20° C. to 25° C.

12. A paste application apparatus as claimed in claim 1, wherein the container stores an ultraviolet cure paste material therein.
